(19) United States
(12) Patent Application Publication
(10) Pub. No.: US 2011/0211280 A1
(43) Pub. Date: Sep. 1, 2011

(54) METHOD AND APPARATUS FOR AT LEAST ONE ACTUATOR ARM DAMPER COVERING AT LEAST ONE LIGHTENING HOLE IN A HARD DISK DRIVE TO REDUCE TRACK MIS-REGISTRATION (TMR)

(76) Inventors: Shiao-Hua Chen, Palo Alto, CA (US); Seungman Chang, Redwood City, CA (US); Chaw-Wu Tseng, San Jose, CA (US)

(21) Appl. No.: 12/714,182

(22) Filed: Feb. 26, 2010

(51) Int. Cl. G11B 5/54

(52) U.S. Cl. 360/254; G9B/5.181

(57) ABSTRACT

This application discloses a hard disk drive, a head stack assembly, an actuator arm, and an arm damper configured for coupling to an actuator arm to create the head stack assembly used in the hard disk drive. The actuator arm has two arm dampers covering a lightening hole on either side of the actuator arm and configured to reduce the effects of airflow turbulence and mechanical vibration in the hard disk drive. Also disclosed, methods of operating the hard disk drive and of manufacturing for the head stack assembly and the hard disk drive.

### TECHNICAL FIELD

This invention relates to reducing Track Mis-Registration in hard disk drives at the actuator arms.

### BACKGROUND OF THE INVENTION

Track Mis-Registration (TMR) is an important, ongoing problem in hard disk drives that often limits the performance, capacity and/or reliability of a unit. Mechanisms and methods are needed that can reduce the TMR.

### SUMMARY OF THE INVENTION

Embodiments of the invention include a hard disk drive comprising a head stack assembly with at least one actuator arm including a lightening hole covered by a first and a second arm damper. Lightening holes are holes in actuator arms that have been used for years to reduce the mass and moment of inertia of the actuator arms in Hard Disk Drives. These arm dampers are configured to streamline airflow around the actuator arm thereby reducing turbulence on the actuator arm and its slider. They are also configured to dampen mechanical vibrations through the actuator arm to the slider. By both reducing the turbulence and dampening mechanical vibration, the arm dampers covering the lightening hole of the actuator arm have been unexpectedly successful at reducing TMR.

In certain embodiments, the first and second arm damper covering the lightening hole of the actuator arm may implement a means for streamlining airflow around the actuator arm and a means for dampening mechanical vibration through the actuator arm to the slider.

At least one of the arm dampers may include a layer of metal and a shock absorbent layer. The metal layer may include stainless steel and the shock absorbent layer may include at least one adhesive layer. The shock absorbent layer may include a viscoelastic damping polymer. The stainless steel minimizes outgassing and provides a smooth surface to help minimize airflow turbulence. The shock absorbent layer both adheres to the actuator arm and tends to dampen mechanical vibration through the actuator arm. The metal layer and/or the shock absorbent layer may be at least partly beveled to further reduce the effects of air turbulence.

The first and/or the second arm damper may further include a pressure equalization aperture that may provide a means for equalizing air pressure between the lightening hole and the surrounding hard disk drive that may also reduce TMR. Equalizing the air pressure helps minimize arm damper deformation due to changes in air pressure and/or air temperature whether or not these constitute airflow turbulence.

The actuator arm may further include a second lightening hole extending through said actuator arm, with the actuator arm further coupled to a third and a fourth arm damper, each covering the second lightening hole. Alternatively, the head stack assembly may include a second actuator arm including the second lightening hole and coupled to an instance of the third and fourth arm dampers, each covering the second lightening hole.

The head stack assembly may further include two or more actuator arms each including lightening holes and each coupled to instances of the first and second arm dampers covering the lightening hole. In some head stack assemblies, each of the actuator arms may include the lightening hole and may be coupled to instances of the first and second arm dampers covering the lightening hole.

### BRIEF DESCRIPTION OF THE DRAWINGS

FIG. 1A shows an example of an embodiment of the invention as a hard disk drive including a disk base to which a spindle motor is mounted with at least one disk rotatably coupled to the spindle motor to create a rotating disk surface. A voice coil motor includes a head stack assembly pivotably mounted by an actuator pivot to the disk base and including an actuator arm coupled to at least one head gimbal assembly configured to position at least one slider to access data stored on the rotating disk surface. The actuator arm is coupled to a first arm damper that covers a lightening hole.

FIG. 1B further shows a cross sectional view of the actuator arm including first arm damper coupling on the first side of the actuator arm and covering the lightening hole extending through the actuator arm. A second arm damper is coupled to a second side of the actuator arm covering the lightening hole. Each of the arm dampers includes a metal layer and a shock absorbent layer and is configured to both reduce airflow turbulence and dampen mechanical vibration.

FIG. 1C shows an exploded cross sectional view of the actuator arm and arm dampers of FIG. 1B.

FIG. 2A shows a perspective view of the voice coil motor, its head stack assembly and one or more head gimbal assemblies coupled to the one or more actuator arms. The head stack assembly is configured position the slider so that its read-write head is positioned close to a track on the rotating disk surface as shown in FIG. 1A. What came as an unexpected result, was that by configuring the actuator arm with arm dampers covering the lightening hole on both sides of the actuator arm, both mechanical vibration and airflow turbulence were reduced thereby improving the Position Error Signal readings, which measure the deviation from the position of the read-write head from the track.

FIG. 2B shows a side view of some details of a head gimbal assembly coupled to the slider showing a commonly understood relationship between airflow turbulence affecting an air bearing formed by the air bearing surface of the slider that is well understood to affect the flying height of the read-write head. It is an unexpected result that reducing airflow turbulence at the actuator arm improves the stability of the read-write head and its flying height.

FIG. 3 shows an alternative embodiment of the head stack assembly including the actuator arm including a second lightening hole that is not covered by arm dampers. The first and/or the second arm damper may further include a pressure equalization aperture configured to mount over the lightening hole that may provide a means for equalizing air pressure between the lightening hole and the surrounding hard disk drive that may also reduce TMR. Equalizing the air pressure helps minimize arm damper deformation due changes in air pressure and/or air temperature whether or not these constitute airflow turbulence.

FIG. 4A shows the first lightening hole uncovered and the second lightening hole covered by the third arm damper and FIG. 4B shows the first lightening hole covered by the first arm damper and the second lightening hole covered by the third arm damper, with these arm dampers coupled on the first side of the actuator arm as further shown in FIG. 5.

And FIG. 5 shows a cross-sectional view of the actuator arm of FIG. 4, further showing the second side of the actuator arm is coupled to the fourth arm damper that covers the second lightening hole.

### DETAILED DESCRIPTION

This application relates to reducing Track Mis-Registration in hard disk drives at the actuator arms. It discloses a hard disk drive, a head stack assembly, an actuator arm, and an arm damper configured for coupling to an actuator arm in the head stack assembly used in the hard disk drive. The actuator arm has two arm dampers covering a lightening hole on either side of the actuator arm and configured to reduce the effects of airflow turbulence and mechanical vibration in the hard disk drive. Also disclosed, methods of operating the hard disk drive and of manufacturing for the head stack assembly and the hard disk drive.

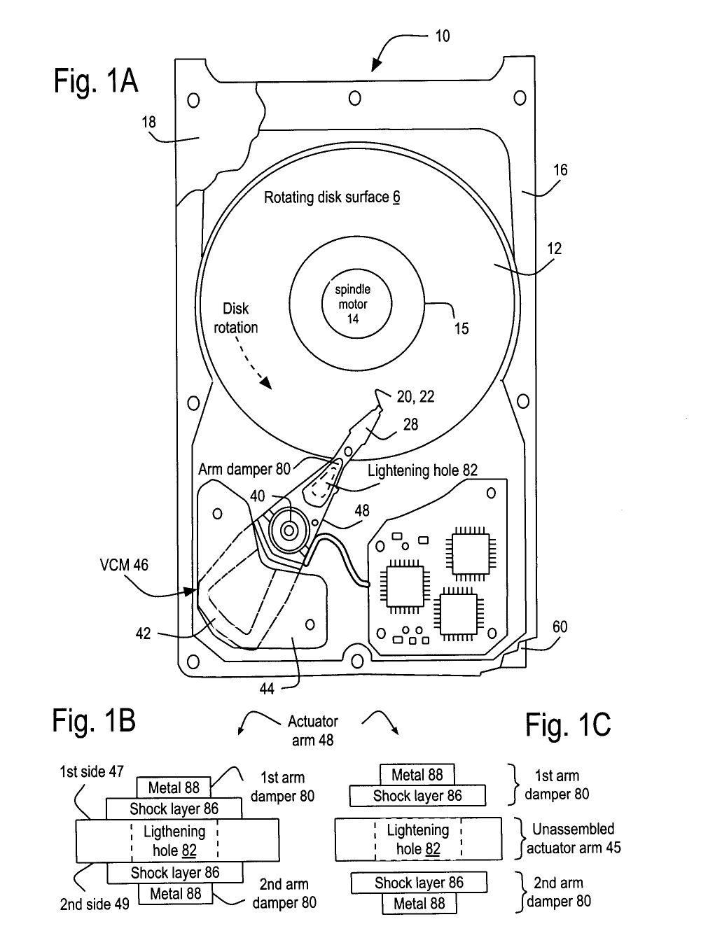

Referring to the drawings more particularly by reference numbers, FIG. 1A shows an example of an embodiment of the invention as a hard disk drive 10 including a disk base 16 to which a spindle motor 14 is mounted with at least one disk 12 rotatably coupled to the spindle motor to create a rotating disk surface 6. A voice coil motor 46 includes a head stack assembly 50 pivotably mounted by an actuator pivot 40 to the disk base, responsive to its voice coil 42 interacting with a fixed magnetic assembly 44 mounted on the disk base and including an actuator arm 48 coupled to at least one head gimbal assembly 28 configured to position at least one slider 20 to access data 15 stored on the rotating disk surface. The actuator arm is coupled to a first arm damper 80 that covers a lightening hole 82.

FIG. 1B further shows a cross sectional view of the actuator arm 48 including a first arm damper 80 coupling on the first side 47 and a second arm damper 80 coupled on a second side 49 of the actuator arm with both arm dampers covering the lightening hole. Each of the arm dampers includes a metal layer 88 and a shock absorbent layer 86 and may be configured to both reduce airflow turbulence and dampen mechanical vibration.

These arm dampers 80 are configured to streamline airflow 27 around the actuator arm 48 thereby reducing turbulence on the actuator arm and its slider 20. They are also configured to dampen mechanical vibrations through the actuator arm to the slider. By reducing the turbulence and dampening mechanical vibration, the arm dampers covering the lightening hole 82 of the actuator arm have been unexpectedly successful at reducing TMR. The hard disk drive 10 operates by streamlining the airflow about the actuator arm with the arm dampers to reduce turbulence on the actuator arm and its slider and by dampening mechanical vibration through the actuator with the arm dampers to the slider.

In certain embodiments, the first and second arm dampers 80 covering the lightening hole 82 of the actuator arm 48 may implement a means for streamlining airflow around the actuator arm and a means for dampening mechanical vibration through the actuator arm to the slider 20.

At least one of the arm dampers 80 may include a layer of metal 88 and a shock absorbent layer 86. The metal layer may include stainless steel and the shock absorbent layer may include at least one adhesive layer. The shock absorbent layer may include a viscoelastic damping polymer. The stainless steel minimizes outgassing and provides a smooth surface to help minimize airflow turbulence. The shock absorbent layer both adheres to the actuator arm and tends to dampen mechanical vibration through the actuator arm. In some embodiments the metal layer may implement the means for streamlining airflow and the shock absorbent layer may implement the means for dampening mechanical vibration.

In some embodiments, the metal layer 88 is at most 0.05 millimeters (mm) thick and may further be at most 0.025 mm thick and further may be 0.0125 mm thick. In some embodiments, the shock absorbent layer 86 may be at most 0.1 mm thick, further may be at most 0.05 mm thick and may further be at most 0.025 mm thick. These layers may or may not have same thickness.

FIG. 1C shows an exploded cross sectional view of the actuator arm 48 and arm dampers 80 of FIG. 1B, with each of the arm dampers 80 including a shock absorbent layer configured to couple to one of the sides 47 or 49 of the unassembled actuator arm 45 to cover the lightening hole 82 extending through the actuator arm. This Figure also helps illustrate the manufacturing process that couples the arm dampers to the sides of the unassembled actuator arm to create the actuator arm.

Returning to FIG. 1A, the hard disk drive 10 includes an assembled circuit board 60 also mounted on the disk base 16 opposite the spindle motor 14 and the voice coil motor 46. A disk cover 18 is mounted on the disk base to encapsulate all of the shown components except the assembled circuit board.

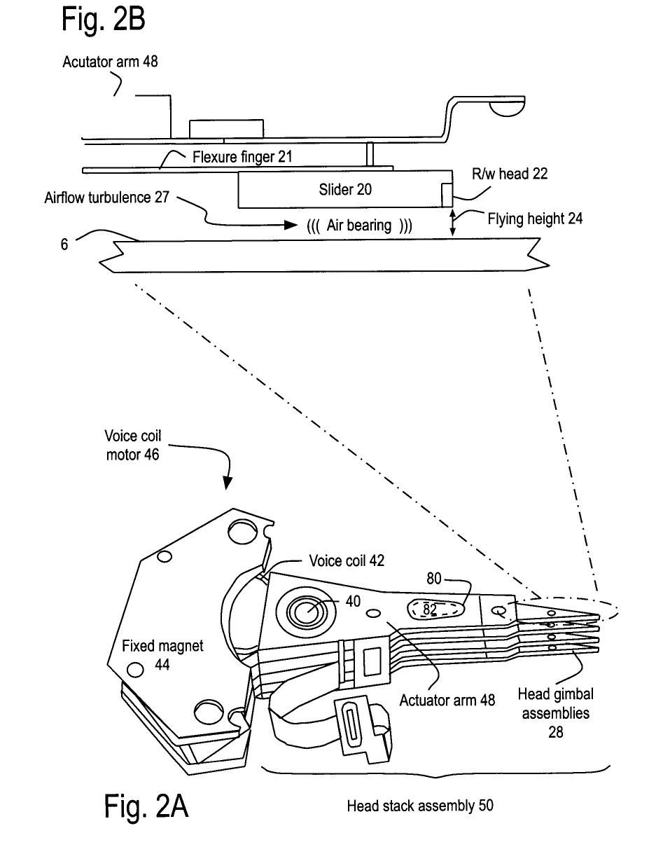

The hard disk drive 10 preferably accesses the data 15 arranged in tracks on the rotating disk surface 6 by controlling the spindle motor 14 to rotate the disks 12 at a preferred rate. The data may be organized as tracks that may be configured as concentric circles or as a tightly packed spiral. The voice coil motor 46 operates by stimulating the voice coil 42 with a time varying electrical signal to magnetically interact with the fixed magnet assembly 44 causing the head stack assembly 50 to pivot about the actuator pivot 40 moving the head gimbal assembly 28 coupled to the actuator arm 48 to position the slider 20 near the track on the rotating disk surface. In many embodiments, a micro-actuator assembly preferably coupled to the slider may be stimulated to further control the position of the slider. A vertical micro-actuator either in the micro-actuator assembly, or preferably in the slider, may be stimulated to alter the flying height 24 shown in FIG. 2B of the slider over the rotating disk surface 6.

FIG. 2A shows a perspective view of the voice coil motor 46, its head stack assembly 50 and one or more head gimbal assemblies 28 coupled to the one or more actuator arms 48 of FIG. 1A. The head stack assembly is configured to pivot about the actuator pivot 40 to position the slider 20 so that its read-write head 22 is position close to a track 15 on the rotating disk surface as shown in FIG. 1A. What came as an unexpected result, was that by configuring the actuator arm with arm dampers 80 covering the lightening hole 82 on both sides 47 and 49 of the actuator arm, both mechanical vibration and airflow turbulence were reduced thereby improving the Position Error Signal readings, which measure the deviation from the position of the read-write head from the track.

FIG. 2B shows a side view of some details of a head gimbal assembly 28 coupled to the slider 20 showing a commonly understood relationship between airflow turbulence 27 affecting an air bearing formed by the air bearing surface of the slider that is well understood to affect the flying height 24 of the read-write head 22. It is an unexpected result that reducing airflow turbulence 27 at the actuator arm 48 improves the stability of the read-write head and its flying height.

The slider 20 may use a perpendicular or longitudinal recording approach to accessing data of the track 15 on the rotating disk surface 6 and may employ a magneto-resistive effect or a tunneling effect to read the data. The slider may include a vertical micro-actuator or the flexure finger 21 may include a vertical micro-actuator. Either approach to vertical micro-actuation may employ a thermal-mechanical effect, a piezoelectric effect, and/or an electro-static effect.

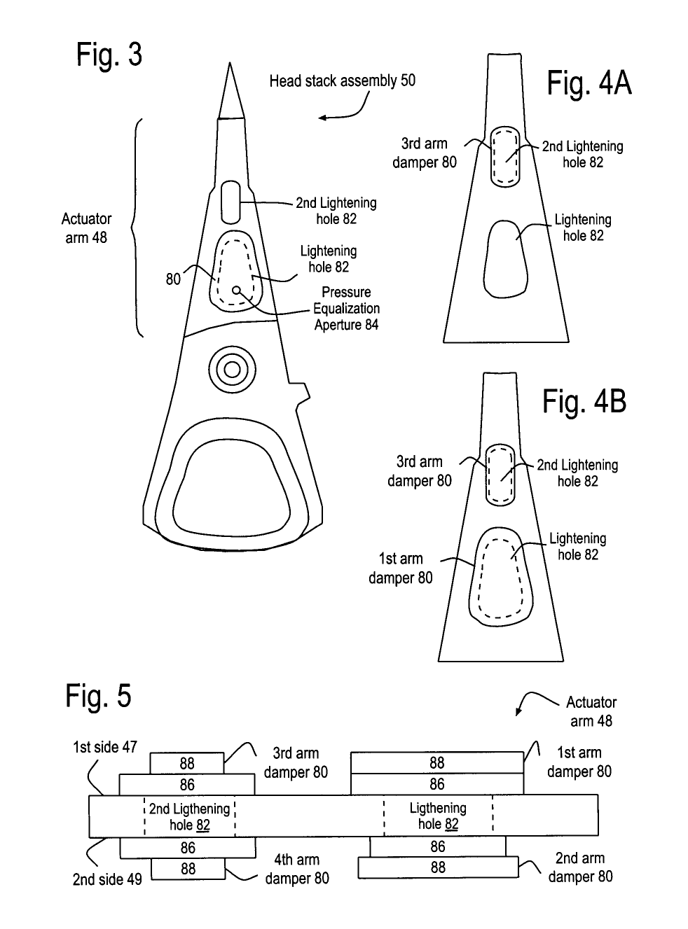

FIG. 3 shows an alternative embodiment of the head stack assembly 50 including the actuator arm 48 including a second lightening hole 82 that is not covered by arm dampers 80. The first and/or the second arm damper 80 may further include a pressure equalization aperture 84 configured to mount over the lightening hole 82 that may provide a means for equalizing air pressure between the lightening hole and the surrounding hard disk drive 10 that may also reduce TMR. Equalizing the air pressure helps minimize the effects of air turbulence. In some embodiments, the pressure equalization aperture is small compared to the area lightening hole covered by the arm dampers. By way of example, the ratio of the pressure equalization aperture to the area covered may be less than twenty percent and may further be less than ten percent, and may further be less than 5 percent.

The head stack assembly 50 may further include two or more actuator arms 48 as shown in FIG. 2A, each including lightening holes 82 and each coupled to instances of the first and second arm dampers 80 covering the lightening hole.

FIGS. 4 and 5 shows another embodiment the actuator arm 48 of FIG. 3, with arm dampers 80 coupled to the actuator arm and covering both lightening holes 82.

FIG. 4A shows the first lightening hole 82 uncovered and the second lightening hole 82 covered by the third arm damper 80 and FIG. 4B shows the first lightening hole covered by the first arm damper 80 and the second lightening hole covered by the third arm damper, with these arm dampers coupled on the first side of the actuator arm as further shown in FIG. 5.

FIG. 5 shows a cross-sectional view of the actuator arm 48 of FIG. 4, further showing the second side 49 of the actuator arm is coupled to the fourth arm damper 80 that covers the second lightening hole 82. In some embodiments, the metal layer 88 may be the same size as the shock absorbent layer 88, as shown for the first arm damper. Alternatively, the metal layer may be larger than the shock absorbent layer as shown for the second arm damper. Further, the metal layer may be smaller than the shock absorbent layer as shown for the third and fourth arm dampers. In one hard disk drive 10, there may be any combination of these situations embodied in the arm dampers.

In some embodiments of the head stack assembly 50, each the actuator arms 48 may include two lightening holes 82. In some head stack assemblies, each of the lightening holes may be covered on both sides 47 and 49 with arm dampers 80. In other head stack assemblies, one actuator arm may have its first lightening hole 82 covered by arm dampers 80. In other head stack assemblies, one actuator arm may have its first lightening hole covered by arm dampers and another of its actuator arms may have only one of its lightening holes covered. Alternative head stack assemblies may include one actuator arm with only its second lightening hole covered.

The preceding embodiments provide examples of the invention, and are not meant to constrain the scope of the following claims.

What is claimed is:

1. A hard disk drive, comprising:
a disk base;
a spindle motor mounted on said disk base and rotatably coupled to at least one disk to create at least one rotating disk surface;
a head stack assembly pivotably mounted by an actuator pivot to said disk base and including
at least one actuator arm configured for placement near said rotating disk surface to aid in positioning a slider on said rotating disk surface,
a first arm damper on a first side of said actuator arm covering a lightening hole extending through said actuator arm, and
a second arm damper on a second side of said actuator arm covering said lightening hole.

2. The hard disk drive of claim 1, wherein said actuator dampers and said actuator arm are configured to reduce airflow turbulence and mechanical vibration.

3. The hard disk drive of claim 2, wherein said actuator dampers and said actuator arm further comprise:
means for streamlining airflow around said actuator arm; and
means for dampening mechanical vibration by said first and second arm dampers through said actuator arm to said slider.

4. The hard disk drive of claim 3, wherein each of said first arm damper and said second arm damper includes a metal layer and a shock absorbent layer.

5. The hard disk drive of claim 4,
wherein said metal layer includes stainless steel; and
wherein said shock absorbent layer includes at least one adhesive layer configured to bond to said actuator arm.

6. The hard disk drive of claim 1, wherein said first arm damper further includes a pressure equalization aperture in gas communication with said lightening hole of said actuator arm.

7. The hard disk drive of claim 1, wherein said head stack assembly further includes
a second actuator arm including a second lightening hole extending through said second actuator arm,
a third arm damper on said first side of said second actuator arm covering said second lightening hole, and
a fourth arm damper on said second side of said second actuator arm covering said second lightening hole.

8. The hard disk drive of claim 1, wherein said second actuator arm further includes
said first arm damper on said first side of said second actuator arm covering said lightening hole extending through said second actuator arm, and
said second arm damper on said second side of said second actuator arm covering said lightening hole.

9. A method, comprising the step of:
operating a hard disk drive including an actuator arm with two arm dampers covering a lightening hole extending through said actuator arm, further comprising the steps of:
streamlining airflow about said actuator arm with said arm dampers to reduce turbulence on said actuator arm and said slider; and
dampening mechanical vibration through said actuator with said arm dampers to said slider.

10. A head stack assembly, including:
at least one actuator arm configured for placement near a rotating disk surface in a hard disk drive,
a first arm damper on a first side of said actuator arm covering a lightening hole extending through said actuator arm, and
a second arm damper, on a second side of said actuator arm covering said lightening hole extending through said actuator arm.

11. The head stack assembly of claim 10, wherein said actuator dampers and said actuator arm are configured to reduce airflow turbulence and mechanical vibration.

12. The head stack assembly of claim 11, wherein said actuator dampers and said actuator arm further comprise:
means for streamlining airflow around said actuator arm; and
means for dampening mechanical vibration by said first and second arm dampers through said actuator arm to said slider.

13. The head stack assembly of claim 12, wherein each of said first arm damper and said second arm damper includes a metal layer and a shock absorbent layer.

14. The head stack assembly of claim 13,
wherein said metal layer includes stainless steel; and
wherein said shock absorbent layer includes at least one adhesive layer configured to bond to said actuator arm.

15. The head stack assembly of claim 10, wherein said first arm damper further includes a pressure equalization aperture in gas communication with said lightening hole of said actuator arm.

16. The head stack assembly of claim 10, further includes
a second actuator arm including a second lightening hole extending through said second actuator arm,
an instance of a third arm damper on said first side of said second actuator arm covering said second lightening hole, and
an instance of a fourth arm damper on said second side of said second actuator arm covering said second lightening hole.

17. The head stack assembly of claim 10, further includes at least two of said actuator arms, each with said first arm damper and said second arm damper covering said lightening hole extending through said actuator arm.

18. An arm damper configured for coupling to an actuator arm in a hard disk drive, comprising:
a metal layer, a shock absorbent layer, and a pressure equalization aperture through said metal layer and said shock absorbent layer, with said arm damper configured to cover configured to mount over said lightening hole extending through said actuator arm in a hard disk drive.

19. The arm damper of claim 18,
wherein said metal layer includes stainless steel; and
wherein said shock absorbent layer includes at least one adhesive layer configured to bond to said actuator arm.

20. The arm damper of claim 18, wherein said shock absorbent layer includes a viscoelastic damping polymer.

21. A method for manufacturing a head stack assembly for use in a hard disk drive, comprising the steps of:
coupling an actuator arm to a first arm damper on a first side and to a second arm damper on a second side, with both arm dampers covering a lightening hole extending through said actuator arm, to create an actuator arm damper assembly; and
coupling said actuator arm damper assembly to a voice coil to create said head stack assembly.

22. The head stack assembly as the product of the process of claim 21.

23. A method for manufacturing said hard disk drive with said head stack assembly of claim 22, comprising the step of:
pivotably mounting said head stack assembly to a disk base and configuring said actuator arm near a rotating disk surface to create said hard disk drive.

24. The hard disk drive as a product of the process of claim 23.
